(19) United States
(12) Patent Application Publication
(10) Pub. No.: US 2018/0315023 A1
(43) Pub. Date: Nov. 1, 2018

(54) SUBJECT MATTER KNOWLEDGE MAPPING

(71) Applicant: General Electric Company, Schenectady, NY (US)

(72) Inventors: Anitha MANGOTHILI, San Ramon, CA (US); Abhishek NARAIN, Bangalore (IN); Manohar SWAMYNATHAN, Bangalore (IN)

(21) Appl. No.: 15/497,700

(22) Filed: Apr. 26, 2017

(51) Int. Cl. G06Q 10/00; G06F 17/30

(52) U.S. Cl. CPC G06Q 10/20; G06F 17/30707

(57) ABSTRACT

The example embodiments are directed to a device and method for preserving and applying the knowledge of a subject matter expert with respect to material and equipment based assets. In one example, the method includes receiving knowledge of a subject matter expert with respect to one or more previous failures of a type of asset, clustering the knowledge into causes of failure, extracting features from the causes to generate a subject matter expert determination mapping, receiving failure information of an asset of a same type as a type of asset associated with the knowledge of the subject matter expert, processing the failure information based on the subject matter expert determination mapping to determine a cause of the failure for the asset, and outputting the determined cause to a display.

### BACKGROUND

Machine and equipment assets, generally, are engineered to perform particular tasks as part of a business process. For example, assets can include, among other things and without limitation, industrial manufacturing equipment on a production line, drilling equipment for use in mining operations, wind turbines that generate electricity on a wind farm, transportation vehicles such as trains and aircraft, and the like. As another example, assets may include devices that aid in diagnosing patients such as imaging devices (e.g., X-ray or MRI systems), monitoring equipment, and the like. The design and implementation of these assets often takes into account both the physics of the task at hand, as well as the environment in which such assets are configured to operate.

Low-level software and hardware-based controllers have long been used to drive machine and equipment assets. However, the rise of inexpensive cloud computing, increasing sensor capabilities, and decreasing sensor costs, as well as the proliferation of mobile technologies have created opportunities for creating novel industrial and healthcare based assets with improved sensing technology and which are capable of transmitting data that can then be distributed throughout a network. As a consequence, there are new opportunities to enhance the business value of some assets through the use of novel industrial-focused hardware and software.

Machine and equipment based assets often fail or need repairs. When an asset fails (e.g., has an issue that requires maintenance or repair), generally a subject matter expert may be used to determine a cause of the failure. The subject matter expert typically has years of experience in analyzing, evaluating, and diagnosing issues and reasons for error/failure associated with the particular asset. In order to make such a determination, a subject matter expert often spends weeks of time analyzing text data such as repair orders, work orders, service orders, notes made by engineers/technicians in the field, materials used, and the like. After analyzing all of this data, a subject matter expert then makes a best-guess as to the cause of an asset failure. However, subject matter experts often leave an organization or move to another position within the organization. As a result, the subject expertise that they brought to the job also leaves with them.

### SUMMARY

Embodiments described herein improve upon the prior art by providing systems and methods which capture the knowledge of a subject matter expert and automatically apply that knowledge to information associated with an asset to generate actionable insights into the asset. For example, the subject matter expert opinion may be applied to text data included within repair orders, work orders, service requests, parts usage, part orders, and the like, to determine what is wrong with an asset, categorize an event that has occurred with the asset, describe a part or a problem in the asset, or otherwise diagnose or characterize a state of the asset. In some examples, the embodiments herein may be incorporated within software that is deployed on a cloud platform for use with an Internet of Things (IoT) system.

In an aspect of an example embodiment, a computer-implemented method includes receiving knowledge developed by one or more subject matter experts from analyzing one or more failures associated with a type of asset, clustering the knowledge into a plurality of causes of failure for the type of asset, respectively, and extracting features from the plurality of causes to generate a subject matter determination mapping for the type of asset, receiving failure information of an asset having a type that is the same as a type of asset associated with the knowledge of the subject matter expert, processing the failure information of the asset based on the subject matter expert determination mapping for the type of asset to determine a cause of the failure from among the plurality of causes for the asset, and outputting the determined cause of failure of the asset to a display.

In an aspect of another example embodiment, a device includes a network interface configured to receive knowledge developed by one or more subject matter experts from analyzing one or more failures associated with a type of asset, a processor configured to cluster the knowledge into a plurality of causes of failure for the type of asset, respectively, and extract features from the plurality of causes to generate a subject matter determination mapping for the type of asset, receive failure information of an asset having a type that is the same as a type of asset associated with the knowledge of the subject matter expert, and process the failure information of the asset based on the subject matter expert determination mapping for the type of asset to determine a cause of the failure from among the plurality of causes for the asset, and an output configured to output the determined cause of failure of the asset to a display.

In an aspect of another example embodiment, a computer readable medium stores instructions that when executed cause a computer to perform a method including receiving knowledge developed by one or more subject matter experts from analyzing one or more failures associated with a type of asset, clustering the knowledge into a plurality of causes of failure for the type of asset, respectively, and extracting features from the plurality of causes to generate a subject matter determination mapping for the type of asset, receiving failure information of an asset having a type that is the same as a type of asset associated with the knowledge of the subject matter expert, processing the failure information of the asset based on the subject matter expert determination mapping for the type of asset to determine a cause of the failure from among the plurality of causes for the asset, and outputting the determined cause of failure of the asset to a display.

Other features and aspects may be apparent from the following detailed description taken in conjunction with the drawings and the claims.

### BRIEF DESCRIPTION OF THE DRAWINGS

Features and advantages of the example embodiments, and the manner in which the same are accomplished, will become more readily apparent with reference to the following detailed description taken in conjunction with the accompanying drawings.

FIG. 1 is a diagram illustrating a cloud computing environment for capturing and applying a subject matter opinion in accordance with an example embodiment.

FIG. 2 is a diagram illustrating a process for capturing and applying knowledge from a subject matter expert in accordance with an example embodiment.

FIGS. 3A and 3B are diagrams illustrating processes associated with clustering knowledge from a subject matter expert in accordance with an example embodiment.

FIG. 4 is a diagram illustrating a method of performing a subject matter expert determination in accordance with an example embodiment.

FIG. 5 is a diagram illustrating a device for performing a subject matter expert determination in accordance with an example embodiment.

Throughout the drawings and the detailed description, unless otherwise described, the same drawing reference numerals will be understood to refer to the same elements, features, and structures. The relative size and depiction of these elements may be exaggerated or adjusted for clarity, illustration, and/or convenience.

### DETAILED DESCRIPTION

In the following description, specific details are set forth in order to provide a thorough understanding of the various example embodiments. It should be appreciated that various modifications to the embodiments will be readily apparent to those skilled in the art, and the generic principles defined herein may be applied to other embodiments and applications without departing from the spirit and scope of the disclosure. Moreover, in the following description, numerous details are set forth for the purpose of explanation. However, one of ordinary skill in the art should understand that embodiments may be practiced without the use of these specific details. In other instances, well-known structures and processes are not shown or described in order not to obscure the description with unnecessary detail. Thus, the present disclosure is not intended to be limited to the embodiments shown, but is to be accorded the widest scope consistent with the principles and features disclosed herein.

As referred to herein, a subject matter expert is someone with subjective experience with a subject or topic, for example, a field of technology, a type of machine, an area of study, and the like, and may include a professional in the field, an engineer, a technician, or the like. Subject matter experts are always in high demand especially in the areas of machine and equipment repair/failure diagnosis. However, when a subject matter expert leaves an organization or moves to a different position within the organization, the organization is now devoid of the knowledge of that expert. Furthermore, it can take an expert days or even weeks of analyzing many different items of information before an expert can make an educated guess as to the cause of a problem with a machine-based or an equipment-based asset. The example embodiments provide a microservice (e.g., software application) that can learn from the knowledge of a subject matter expert, for example, through historical opinions of the expert and the data that they used to make their opinion, and apply that knowledge to newly received data thereby rendering an opinion of the expert on the new data without involving the expert. For example, the application can analyze significant amounts of textual-based data related to a machine or equipment failure, compare the data to a determination mechanism, and almost instantaneously classify the failure as being related to one or more causes rather than waiting days or even weeks for a human actor to make a determination. As described herein, a “failure” refers to any event that causes a machine or equipment to stop working as expected.

In various embodiments, the subject matter may include industrial and/or manufacturing based equipment, machines, devices, etc., and may include healthcare machines, industrial machines, manufacturing machines, chemical processing machines, textile machines, locomotives, aircraft, energy-based machines, oil rigs, and the like. The application may analyze textual data generated by a subject matter expert or generated in association with a failure event of an asset type and cluster the textual data into groups, and also extract keywords, phrases, short descriptions, etc. which are commonly found in certain failure situations. As a non-limiting example, the phrase “bolt loosened” or “bolt missing” may be a phrase that commonly identifies a compressor failure in an HVAC system. Accordingly, the phrase “bolt loosened” or “bolt missing” may be mapped to the cause of failure as compressor failure. It should also be appreciated that the subject matter expert service described herein is capable of automatically mapping an opinion of the subject matter expert opinion in various types of scenarios, and not just asset failure analysis. Any time there is textual data associated with the subject matter expert opinion and a classification or other analysis, the embodiments herein can be provided. For example, the application may analyze part descriptions, and automatically cluster and classify parts based on the subject matter expert opinion for part classifications. In this case, the subject matter expert can go through the clustering/classifications and agree with them or modify/add to them.

In some cases, the clustered results can be further refined based on feedback from the expert themselves to eliminate any anomalies and further refine the learning. Based on the clustered data, the application can analyze a same type of data or a different type of data to generate a subject matter expert opinion of the data. In various examples, subject matter opinions include identifying what is wrong with a machine or equipment, describing a problem or a part, event categorization, and the like.

The subject matter expert software may be an application or a service that is deployed on a cloud platform computing environment, for example, an Internet of Things (IoT) or an Industrial Internet of Things (IIoT) based platform. While progress with machine and equipment automation has been made over the last several decades, and assets have become ‘smarter,’ the intelligence of any individual asset pales in comparison to intelligence that can be gained when multiple smart devices are connected together, for example, in the cloud. Assets, as described herein, may refer to equipment and machines used in fields such as energy, healthcare, transportation, heavy manufacturing, chemical production, printing and publishing, electronics, textiles, and the like. Aggregating data collected from or about multiple assets can enable users to improve business processes, for example by improving effectiveness of asset maintenance or improving operational performance if appropriate industrial-specific data collection and modeling technology is developed and applied.

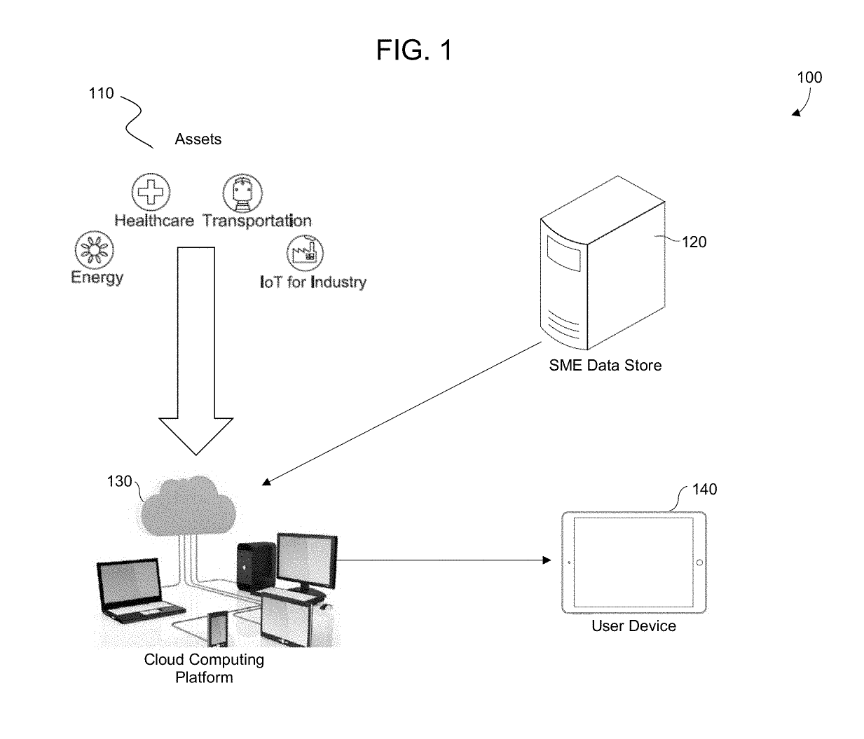

FIG. 1 illustrates a cloud-based system 100 for preserving and applying subject matter expert knowledge in accordance with an example embodiment. In this example, the subject matter expert is associated with one or more types of assets. Referring to FIG. 1, the system 100 includes a group of assets 110, subject matter expert (SME) data store 120, a cloud computing platform (e.g., cloud platform) 130 that represents a cloud-based environment according to various embodiments, and a user device 140. It should be appreciated that the system 100 is merely an example and may include additional devices and/or one of the devices shown may be omitted. As another example, the software described herein may be included on a single device without the interaction of a system. The cloud computing platform 130 may be one or more of a server, a computer, a database, and the like, included in a cloud-based platform. The user device 140 may include a computer, a laptop, a tablet, a mobile device, a television, an appliance, a kiosk, and the like. In the example of FIG. 1, the assets 110, the SME data store 120, and/or the user device 140 may be connected to the cloud platform 130 via a network such as the Internet.

An asset 110 may be outfitted with one or more sensors configured to monitor respective operations or conditions. Data from the sensors can be recorded or transmitted to the cloud-based or other remote computing environment described herein. By bringing such data into a cloud-based computing environment 100, subject matter experts may analyze issues such as machine or equipment failure and provide a subjective opinion as to the reason for such failure, part classification, and the like, based on a totality of evidence (e.g., textual data) from multiple different sources. These opinions along with the data used by the subject matter expert to make such an opinion may be stored in SME data store 120. Insights gained through analysis of such data can lead to enhanced asset designs, enhanced software algorithms for operating the same or similar assets, better operating efficiency, and the like. In addition, analytics may be used to analyze, evaluate, and further understand issues related to manufacturing. However, expert opinions can often take a significant amount of time because it requires the expert to read through significant amounts of data, apply their personal experience/knowledge on the subject matter, and render an opinion.

According to various embodiments, a service that learns from the data of previous failures of an asset as well as opinions of a subject matter expert with respect to the previous failures, generates a knowledge engine based on what is learned, and applies the knowledge to an asset of the type, may be deployed on the cloud computing platform 130. The service may receive new data about an asset that has failed and determine a cause of the failure based on the failure data compared with the knowledge engine without the need for the subject matter expert to become involved. Accordingly, if the subject matter expert is unavailable for whatever reason, or merely to supplement a subject matter expert's opinion, the service described herein may provide an automated determination of a cause of failure of an asset and output the determination to a screen of the user device 140.

Subject matter expert data with respect to a type of asset such as a particular machine or equipment used in industry/manufacturing may be stored in SME data store 120. For example, the subject matter expert data may include the determination of the cause of failure rendered by the subject matter expert themselves as well as data related to the failure which was used by the subject matter expert in rendering the opinion. The related data may not be prepared by the subject matter expert but may be prepared by others in response to the failure such as work orders, workshop notes, material purchase orders, repair orders, and the like, with respect to a particular type of asset. The data may include textual based data that is provided when repairing or fixing the asset and which is used by the subject matter expert in making a determination.

The software application described herein and deployed on the cloud platform 130 in FIG. 1 may learn from the subject matter expert data stored in the SME data store 120, and generate a subject matter expert determination mapping or engine. For example, the historical information provided in connection with previous failures of a type of asset may be analyzed and clustered into different failure topics or causes. As will be appreciated, a type of asset (e.g., type of machine or equipment) may have hundreds of causes of failure. For example, a healthcare machine or a manufacturing machine may have hundreds of parts and/or software that need repair or replacement. Accordingly, there may be hundreds of clusters of textual data as well as opinion information of the subject matter expert for each cause of failure.

The clustering may include clustering textual data from work orders, material orders, repair notes, and the like, into a particular cause from among a plurality of causes for a type of asset. That is, the cause may be identified by a subject matter expert while the associated data may be used by the subject matter expert to render the opinion. In some examples, each cause may correspond to a single cluster, however, the embodiments are not limited thereto. After the initial data has been clustered into causes or other topics, the application may analyze the textual data included in each of the clusters (i.e., work orders, notes, etc.) and identify/extract particular keywords and phrases that correspond to a cause of failure for the type of asset. The application may generate a map between the keywords/phrases and the particular failure may be stored somewhere that is accessible to the service such as on the cloud platform 130, the SME data store 120, or the like, and be available to the service for later use. Here, the keywords may be words that uniquely identify a particular failure.

The mapping information may be used to generate a subject matter determination mechanism that includes a mapping of features that identify causes of failure and which enables the service to analyze a new failure information of the same type of asset and automatically determine a failure based on historical opinions of the subject matter expert and the data associated therewith that have been preserved in the mapping information of the subject matter determination mechanism. When new failure information of the same type asset is received, for example, from an asset 110 or a system associated with the asset 110, the failure information may processed by the application deployed on the cloud platform 130 to automatically determine a cause for the failure based on the subject matter determination mapping.

The determined failure may be output to a display screen of the user device 140, or another device. For example, the user device 140 (e.g., computer, mobile device, workstation, tablet, laptop, appliance, kiosk, and the like) may be configured for data communication with the cloud computing platform 130. The user device 140 can be used to monitor or control an asset 110, or shipping plans, maintenance plans, repairs, and the like, related to the asset 110. In an example, information about a cause of failure of the asset 110 may be presented to an operator via a display of the user device 140. The user device 140 can include options and hardware for scheduling repairs and/or parts for the asset 110.

As another example, the user device 140 may correspond to a device of a subject matter expert themselves. The subject matter expert (via the user device 140) may remotely connect to the application deployed on the cloud platform 130 and modify the subject matter expert determination mapping by removing anomalies or refining particular keywords/phrases to further enhance the correctness of the application described herein.

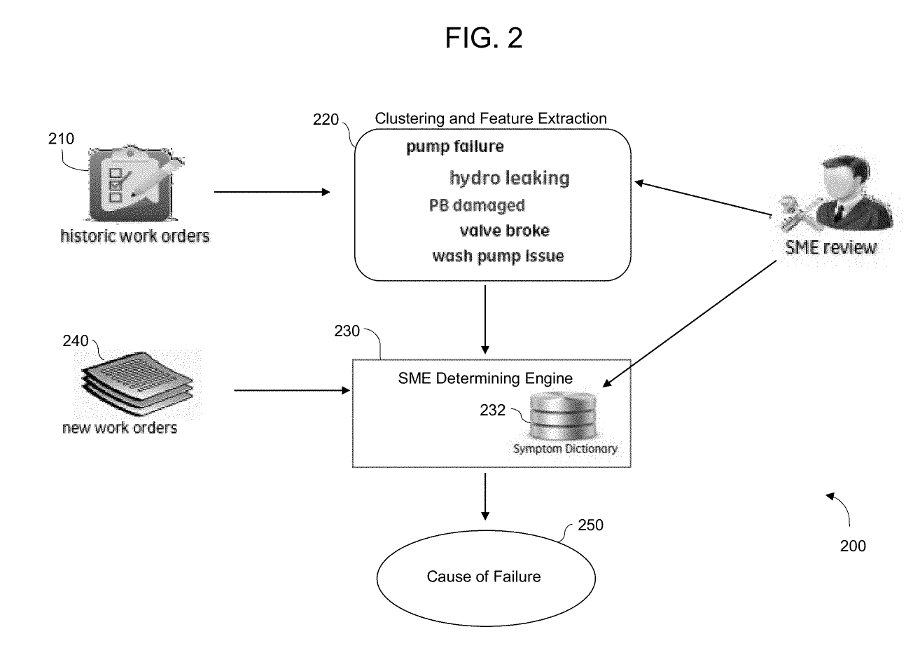

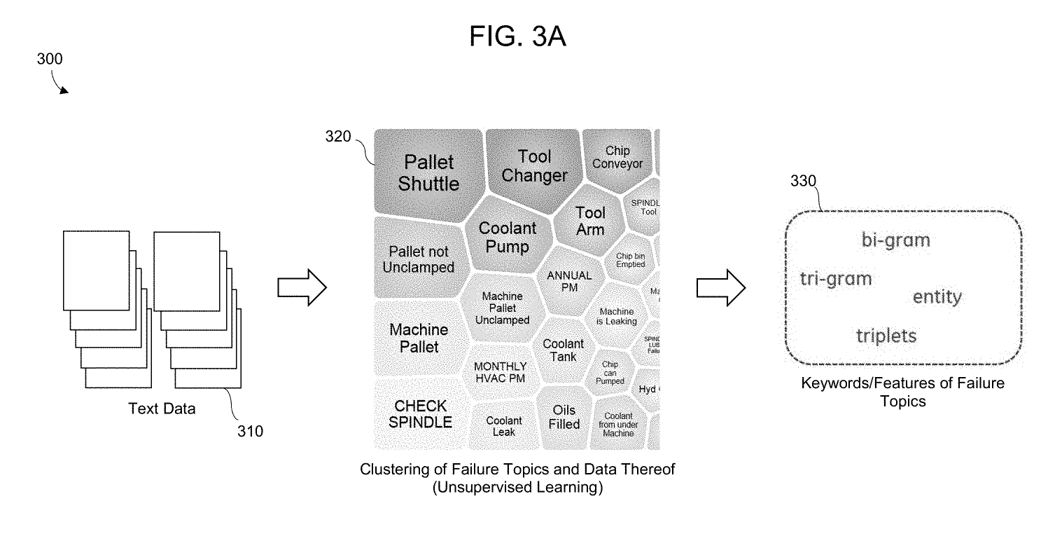

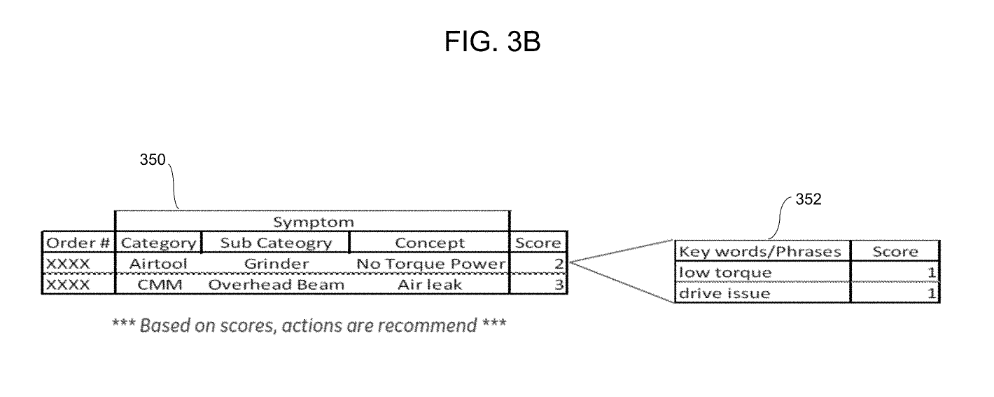

FIG. 2 illustrates a process 200 or capturing and applying knowledge from a subject matter expert in accordance with an example embodiment, and FIG. 3 illustrates a process 300 of clustering knowledge from a subject matter expert in accordance with an example embodiment. Referring to FIG. 2, in 210, textual data associated with previous subject matter expert determinations with respect to a particular type of asset (e.g., aircraft, locomotive, plant equipment, manufacturing machine, healthcare device, etc.) is received by the application from one or more sources. The textual data may include a determination by the subject matter expert as the reason for failure, and materials that are used by a subject matter expert to make the determination. In 220, the textual data is analyzed and clustered into particular topics, for example, causes of failure. Here, each cause of failure may be clustered into its own respective cluster. However, the embodiments are not limited thereto. As another example, each failure may have a plurality of clusters that are clustered based on additional details or more refined details of the failure.

In addition, feature extraction is performed in 220 and a mapping is generated between keywords/features and particular causes of failure for a type of asset and stored by a symptom dictionary 232 included in an SME determining engine 230. For example, as shown in the process 300 of FIG. 3A, the text data 310 associated with a subject matter expert may include text data from documents, files, XML data, web pages, design documents, material purchase orders, and the like, which include data surrounding an asset failure event which is used by the subject matter expert to determine a cause of failure of a type of asset. The clustering in 320 may be performed as a form of unsupervised learning. The clustering may be automated such that textual data associated with dozens or even hundreds of previous failures (which have determinations previously rendered by subject matter experts), are clustered into groups based on failure types for the asset. Keywords/features may be extracted in 330 from each cluster to generate particular keywords/features that uniquely identify a particular cause of failure. The keywords may be extracted based on word relationships from neighboring words such as bi-grams, tri-grams, n-grams, and the like. Also, the words do not need to be consecutively arranged by may be arranged within a predetermined distance from one another in a sentence or paragraph.

Based on the clustered data and the extracted keywords a mapping such as mapping table 350 shown in FIG. 3B may be generated. In this example, the mapping table 350 includes a plurality of causes of failure for a particular asset as well as attributes of each cause that may be identified from the initial data such as work orders, material purchase orders, repairmen notes, etc. The service described herein may identify and extract keywords/phrases 352 related to each respective cause of failure. In the example of FIG. 3B, the phrases “low torque” and “drive issue” are key phrases identifying a compressor (e.g., from an air tool) that has lost power. When these phrases “low torque” and/or “drive issue” are identified from new failure information of the same asset type, the service may determine that the new failure is the result of a compressor that has lost power. In some examples, the service may generate a score for each of a plurality of causes of failure based on the comparing of the mapping table with the new failure information and select the cause of failure having the highest score, or the like.

Referring again to FIG. 2, in some embodiments, a subject matter expert may review the clustering, feature extraction, and mapping generation results and modify or refine the results to remove anomalies and further enhance the correctness of the algorithm. The resulting mapping information included in the SME determining engine 230 may be applied to new work orders 240 (or other textual data surrounding a failure such as materials orders, workshop notes, etc.) Accordingly, in 250 a cause of failure for the new work orders 240 may be determined automatically.

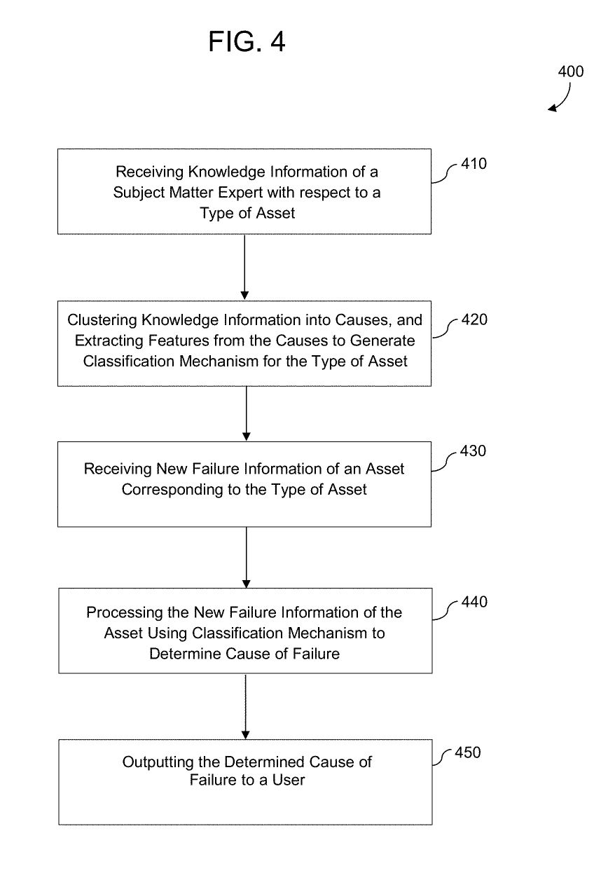

FIG. 4 illustrates a method 400 for performing a subject matter expert determination in accordance with an example embodiment. For example, the method 400 may be performed by a computing device, a server, a cloud platform, and/or the like. Referring to FIG. 4, in 410, the method includes receiving knowledge-related information of a subject matter expert with respect to previous failures of a type of asset. For example, the asset may include a machine or equipment used one of the fields of industry such as healthcare, transportation, energy, manufacture, and the like, and the subject matter expert may include a professional, a technician, an engineer, or the like, who has personal experience with the type of asset. The knowledge-related information may include work orders, opinions, decisions, descriptions, determinations, etc. provided repairmen, technicians, etc. which are used by a subject matter expert to determine a cause of failure of the type of asset. The knowledge-related information may be accumulated from multiple different failures of an asset type and from multiple different subject matter experts. The knowledge-related information may be identified from textual data included in a failure diagnosis, a repair order, a work order, and/or the like, generated by a subject matter expert. That is, the knowledge-related information may include subjective knowledge that is gleaned from data surrounding a failure or a failure event when determining a cause of failure of the asset or other issues with the asset.

In 420, the method includes clustering the knowledge-related information into a plurality of causes of failure for the type of asset, and extracting features from the plurality of causes to generate a subject matter determination mapping for the type of asset. For example, textual data from the knowledge-related information may be clustered based on types of failures from among dozens or even hundreds of causes of asset failure for a particular type of asset. The clustered textual information may be further analyzed to identify keywords and/or phrases that are repetitively identified from textual data associated with a particular cause of failure for the asset, and the keywords/phrase may be stored in a file, table, etc. such as a mapping table. Here, each cause of failure for a type of asset may include one or more keywords and/or phrases mapped thereto. The mapped information may be stored as a subject matter expert determination mapping that can be used to automatically apply the opinion of the subject matter expert to a new set of data. In one example, the mapped information may include a mapping dictionary that maps causes of failure for the type of asset to one or more respective keywords.

In 430, the method includes receiving failure information of an asset having a type that is the same as a type of asset associated with the knowledge-related information of the subject matter expert. For example, the failure information may include similar information as is used to build the subject matter expert determination mapping, and may include information about a failure event such as a repair order, a materials purchase order, shop comments or descriptions, engineer comments, and the like. The failure information may not include a determination of a cause of failure from a subject matter expert. Instead, in 440, the method includes processing the failure information of the asset based on the subject matter expert determination mapping for the type of asset to automatically determine a cause of the failure from among the plurality of causes for the asset, and, in 450, outputting the determined cause of failure of the asset to a display. For example, the processing of the failure information in 440 may include comparing textual data associated with the failure of the asset to respective keywords of the plurality of causes of failure, and mapping the failure to at least one cause based on the comparing. Although not shown in FIG. 4, the method may further include receiving input from the subject matter expert that refines the clustering of the knowledge-related information of the subject matter expert. For example, the input form the subject matter expert may remove outliers from a cluster, and the like.

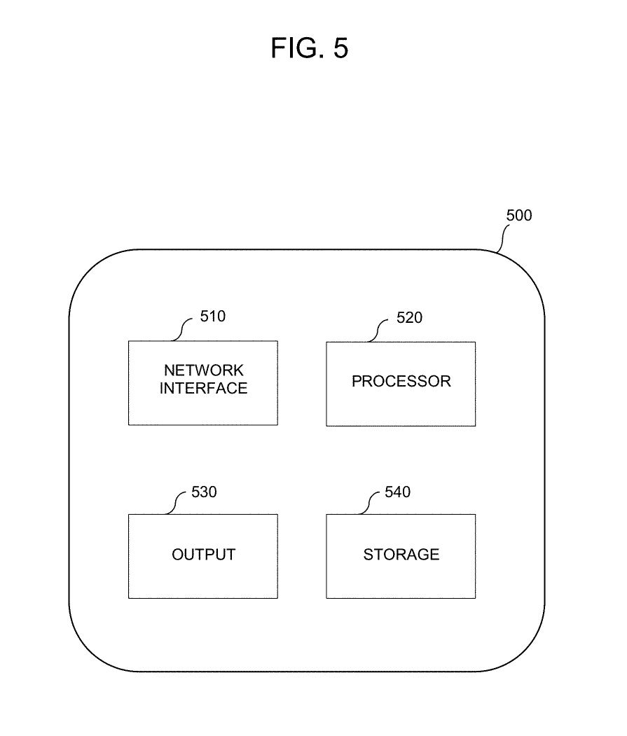

FIG. 5 illustrates a device 500 for performing a subject matter expert determination in accordance with an example embodiment. For example, the device 500 may perform the method 400 of FIG. 4. Referring to FIG. 5, the device 500 includes a network interface 510, a processor 520, an output 530, and a storage device 540. Although not shown in FIG. 5, the device 500 may include other components such as a display, an input unit, a receiver/transmitter, and the like. The network interface 510 may transmit and receive data over a network such as the Internet, a private network, a public network, and the like. The network interface 510 may be a wireless interface, a wired interface, or a combination thereof. The processor 520 may include one or more processing devices each including one or more processing cores. In some examples, the processor 520 is a multicore processor or a plurality of multicore processors. Also, the processor 520 may be fixed or it may be reconfigurable. The output 530 may output data to an embedded display of the device 500, an externally connected display, a cloud, another device, and the like. The storage device 540 is not limited to any particular storage device and may include any known memory device such as RAM, ROM, hard disk, and the like.

For example, the network interface 510 may receive knowledge-related information of a subject matter expert with respect to previous failures of a type of asset. For example, the type of asset may include at least one of a machine and an equipment, which are included within an Industrial Internet of Things (IIoT) network, and the knowledge-related information of the subject matter expert may include textual data (e.g., opinions, determinations, repairs, notes, materials orders, etc.) used by the subject matter expert in determining a previous cause of failure of the asset. The processor 520 may analyze the subject matter expert textual data, cluster the textual data into clusters in which each cluster represents a respective cause of failure from among a plurality of causes of failure for the type of asset, and extract features from the plurality of causes to generate a subject matter determination mapping for the type of asset. For example, the features of a cause of failure extracted by the processor 520 may include one or more keywords that are repetitively used within textual data associated with and surrounding a cause of failure. The processor 520 may generate the subject matter determination mapping by mapping keywords to particular failures and storing the mapping in the storage 540.

In some embodiments, the processor 520 may receive failure information of an asset having a type that is the same as a type of asset associated with the knowledge-related information of the subject matter expert, and process the newly received failure information based on the subject matter expert determination mapping to determine a cause of the failure for the asset. The subject matter expert determination mapping generated by the processor may include a mapping dictionary that maps each possible cause of failure for the type of asset to one or more respective keywords/phrases. In this example, the processor 520 may compare newly received textual data of a new failure of an asset with the previously stored mapping information of previous failures that are based on determinations made by one or more subject matter experts, and automatically render an opinion of the subject matter expert without input from the subject matter expert with respect to the new failure. In other words, the processor 520 may take the historical knowledge of an expert and apply it to new failure information in order to automate the process of providing the expert opinion. Furthermore, the output 530 may output a determination of the cause of failure of the asset to a display such as an embedded display of the device 500 or a display that is externally connected to the device 500 through a cable, a network, a cloud, and/or the like.

In some embodiments, the device 500 may include an input unit that receives input from a subject matter expert that refines the clustering of the knowledge-related information of the subject matter expert. For example, the subject matter expert may remove discrepancies, identify outliers that do not belong in a particular cluster, and the like. As another example, the input of the subject matter expert may be input into and received from another device via the network interface 510.

As will be appreciated based on the foregoing specification, the above-described examples of the disclosure may be implemented using computer programming or engineering techniques including computer software, firmware, hardware or any combination or subset thereof. Any such resulting program, having computer-readable code, may be embodied or provided within one or more non transitory computer-readable media, thereby making a computer program product, i.e., an article of manufacture, according to the discussed examples of the disclosure. For example, the non-transitory computer-readable media may be, but is not limited to, a fixed drive, diskette, optical disk, magnetic tape, flash memory, semiconductor memory such as read-only memory (ROM), and/or any transmitting/receiving medium such as the Internet, cloud storage, the internet of things, or other communication network or link. The article of manufacture containing the computer code may be made and/or used by executing the code directly from one medium, by copying the code from one medium to another medium, or by transmitting the code over a network.

The computer programs (also referred to as programs, software, software applications, “apps”, or code) may include machine instructions for a programmable processor, and may be implemented in a high-level procedural and/or object-oriented programming language, and/or in assembly/machine language. As used herein, the terms “machine-readable medium” and “computer-readable medium” refer to any computer program product, apparatus, cloud storage, internet of things, and/or device (e.g., magnetic discs, optical disks, memory, programmable logic devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal that may be used to provide machine instructions and/or any other kind of data to a programmable processor.

The above descriptions and illustrations of processes herein should not be considered to imply a fixed order for performing the process steps. Rather, the process steps may be performed in any order that is practicable, including simultaneous performance of at least some steps. Although the disclosure has been described in connection with specific examples, it should be understood that various changes, substitutions, and alterations apparent to those skilled in the art can be made to the disclosed embodiments without departing from the spirit and scope of the disclosure as set forth in the appended claims.

What is claimed is:

1. A computer-implemented method comprising:
receiving knowledge developed by one or more subject matter experts from analyzing one or more failures associated with a type of asset;
clustering the knowledge into a plurality of causes of failure for the type of asset, respectively, and extracting features from the plurality of causes to generate a subject matter determination mapping for the type of asset;
receiving failure information of an asset having a type that is the same as a type of asset associated with the knowledge of the subject matter expert;
processing the failure information of the asset based on the subject matter expert determination mapping for the type of asset to determine a cause of the failure from among the plurality of causes for the asset; and
outputting the determined cause of failure of the asset to a display.

2. The computer-implemented method of claim 1, wherein the type of asset comprises at least one of a machine and an equipment, and where the asset is included within an Industrial Internet of Things (IIoT) network.

3. The computer-implemented method of claim 1, wherein the knowledge of the subject matter expert comprises textual data used by the subject matter expert in determining a cause of failure and includes at least one of a work order, a materials purchase order, and repair notes.

4. The computer-implemented method of claim 1, wherein the subject matter expert comprises at least one of a professional, a technician, and an engineer, who has personal experience with the type of asset.

5. The computer-implemented method of claim 1, wherein the extracted features of a cause of failure comprise one or more keywords that are identified with respect to the cause of failure.

6. The computer-implemented method of claim 1, wherein the subject matter expert determination mapping comprises a mapping dictionary that maps a plurality of causes of failure for the type of asset to one or more respective keywords that are identified in text data associated with the cause of failure.

7. The computer-implemented method of claim 6, wherein the processing of the failure information comprises comparing textual data associated with the failure of the asset to respective keywords of the plurality of causes of failure, and mapping the failure to at least one cause based on the comparing.

8. The computer-implemented method of claim 1, wherein the clustering further comprises receiving input from the subject matter expert that refines the clustering of the knowledge of the subject matter expert.

9. A computer system comprising:
a network interface configured to receive knowledge developed by one or more subject matter experts from analyzing one or more failures associated with a type of asset;
a processor configured to
cluster the knowledge into a plurality of causes of failure for the type of asset, respectively, and extract features from the plurality of causes to generate a subject matter determination mapping for the type of asset,
receive failure information of an asset having a type that is the same as a type of asset associated with the knowledge of the subject matter expert, and
process the failure information of the asset based on the subject matter expert determination mapping for the type of asset to determine a cause of the failure from among the plurality of causes for the asset; and
an output configured to output the determined cause of failure of the asset to a display.

10. The computer system of claim 9, wherein the type of asset comprises at least one of a machine and an equipment, and where the asset is included within an Industrial Internet of Things (IIoT) network.

11. The computer system of claim 9, wherein the knowledge of the subject matter expert comprises textual data used by the subject matter expert in determining a cause of failure and includes at least one of a work order, a materials purchase order, and repair notes.

12. The computer system of claim 9, wherein the subject matter expert comprises at least one of a professional, a technician, and an engineer, who has personal experience with the type of asset.

13. The computer system of claim 9, wherein the features of a cause of failure extracted by the processor comprise one or more keywords that are identified with respect to the cause of failure.

14. The computer system of claim 9, wherein the subject matter expert determination mapping generated by the processor comprises a mapping dictionary that maps a plurality of causes of failure for the type of asset to one or more respective keywords that are identified in text data associated with the cause of failure.

15. The computer system of claim 14, wherein the processor is configured to compare textual data associated with the failure of the asset to respective keywords of the plurality of causes of failure, and map the failure to at least one cause based on the comparing.

16. The computer system of claim 9, wherein the processor is further configured to receive input from the subject matter expert that refines the clustering of the knowledge of the subject matter expert.

17. A non-transitory computer readable medium having stored therein instructions that when executed cause a computer to perform a method comprising:
receiving knowledge developed by one or more subject matter experts from analyzing one or more failures associated with a type of asset;
clustering the knowledge into a plurality of causes of failure for the type of asset, respectively, and extracting features from the plurality of causes to generate a subject matter determination mapping for the type of asset;
receiving failure information of an asset having a type that is the same as a type of asset associated with the knowledge of the subject matter expert;
processing the failure information of the asset based on the subject matter expert determination mapping for the type of asset to determine a cause of the failure from among the plurality of causes for the asset; and
outputting the determined cause of failure of the asset to a display.

18. The non-transitory computer readable medium of claim 17, wherein the type of asset comprises at least one of a machine and an equipment, and where the asset is included within an Industrial Internet of Things (IIoT) network.

19. The non-transitory computer readable medium of claim 17, wherein the knowledge of the subject matter expert comprises textual data used by the subject matter expert in determining a cause of failure and includes at least one of a work order, a materials purchase order, and repair notes.

20. The non-transitory computer readable medium of claim 17, wherein the subject matter expert comprises at least one of a professional, a technician, and an engineer, who has personal experience with the type of asset.
